(19) United States
(12) Patent Application Publication
(10) Pub. No.: US 2019/0273532 A1
(43) Pub. Date: Sep. 5, 2019

(54) CARRIER FREQUENCY OFFSET ESTIMATION DEVICE AND CARRIER FREQUENCY OFFSET ESTIMATION METHOD

(71) Applicant: MStar Semiconductor, Inc., Hsinchu Hsien (TW)

(72) Inventors: Kuan-Chou LEE, Hsinchu Hsien (TW); Kai-Wen CHENG, Hsinchu Hsien (TW); Chia-Wei CHEN, Hsinchu Hsien (TW); Tai-Lai TUNG, Hsinchu Hsien (TW)

(21) Appl. No.: 16/102,841

(22) Filed: Aug. 14, 2018

(30) Foreign Application Priority Data
Mar. 1, 2018 (TW) 107106723

(51) Int. Cl. H04B 3/23

(52) U.S. Cl. CPC H04B 3/237; H04B 3/234; H04B 3/232

(57) ABSTRACT

A carrier frequency offset (CFO) estimation device includes an echo cancelling unit, performing echo cancellation on an input signal to generate an echo-cancelled signal; and a CFO estimating unit, performing CFO estimation on the echo-cancelled signal to generate an estimated CFO.

This application claims the benefit of Taiwan application Serial No. 107106723, filed on Mar. 1, 2018, the subject matter of which is incorporated herein by reference.

### BACKGROUND OF THE INVENTION

### Field of the Invention

The invention relates to carrier frequency offset (CFO) estimation, and more particularly to CFO estimation that cancels echo in advance.

### Description of the Related Art

Each of a transmitting end and a receiving end in a communication system is provided with at least one oscillation signal source (e.g., a quartz oscillator) for providing clock signals as reference for circuit operations thereof. A difference between the frequency of clock signals at a receiving end and that at a transmitting end is referred to as a carrier frequency offset (CFO), which may cause the receiving end to be unable to correctly read and parse signals from the transmitting end. To avoid the above issue, a receiving end needs to estimate the CFO so as to perform compensation accordingly.

FIG. 1 shows a block diagram of a conventional CFO estimation device. The CFO estimation device 100 includes a fourth-power circuit 110, a fast Fourier transform (FFT) circuit 120, a maximum peak frequency determining circuit 130 and a division circuit 140. The fourth-power circuit 110 performs a fourth-power calculation on a received signal R to generate a fourth-power calculation result R⁴. The FFT circuit 120 performs FFT on the fourth-power calculation result R⁴ to generate a spectrum Z of the fourth-power calculation result R⁴, as shown in FIG. 2. The maximum peak frequency determining circuit 130 then identifies a maximum peak P_{MAX} from the spectrum Z, and outputs a peak frequency Ω corresponding to the maximum peak P_{MAX}. The division circuit 140 divides the peak frequency Ω by four to obtain a calculation result, and uses the calculation result as an estimated CFO E. However, when the received signal R is transmitted to a receiving end through a multipath, the received signal R is frequently mixed with echo, such that the peak frequency Ω corresponding to the maximum peak P_{MAX} of the spectrum Z significantly deviates from a value four times the actual CFO, causing inaccurate CFO estimation of the CFO estimation device 100.

### SUMMARY OF THE INVENTION

Therefore, it is an object of the present invention to provide a carrier frequency offset (CFO) estimation device and a CFO estimation method for preventing inaccurate CFO estimation.

A CFO estimation device disclosed by the present invention includes: an echo cancelling unit, performing echo cancellation to generate an echo-cancelled signal; and a CFO estimating unit, performing CFO estimation according to the echo-cancelled signal to generate an estimated CFO.

A CFO estimation method further disclosed by the present invention includes: performing echo cancellation on a received signal to generate an echo-cancelled signal; and performing CFO estimation according to the echo-cancelled to generate an estimated CFO.

The above and other aspects of the invention will become better understood with regard to the following detailed description of the non-limiting embodiments. The following description is made with reference to the accompanying drawings.

### BRIEF DESCRIPTION OF THE DRAWINGS

FIG. 1 is a block diagram of a conventional carrier frequency offset (CFO) estimation device;

FIG. 2 is a schematic diagram of an exemplary spectrum of a fourth-power calculation result;

FIG. 3 is a block diagram of a CFO estimation device according to an embodiment of the present invention;

FIG. 4 is a flowchart of a CFO estimation method according to an embodiment of the present invention;

FIG. 5 is a block diagram of an echo cancelling unit according to an embodiment of the present invention;

FIG. 6 is a flowchart of an echo cancelling method according to an embodiment of the present invention;

FIG. 7 is a block diagram of a CFO estimating unit according to an embodiment of the present invention;

FIG. 8 is a block diagram of a coefficient generating unit according to an embodiment of the present invention; and

FIG. 9 is a flowchart of a coefficient generating method according to an embodiment of the present invention.

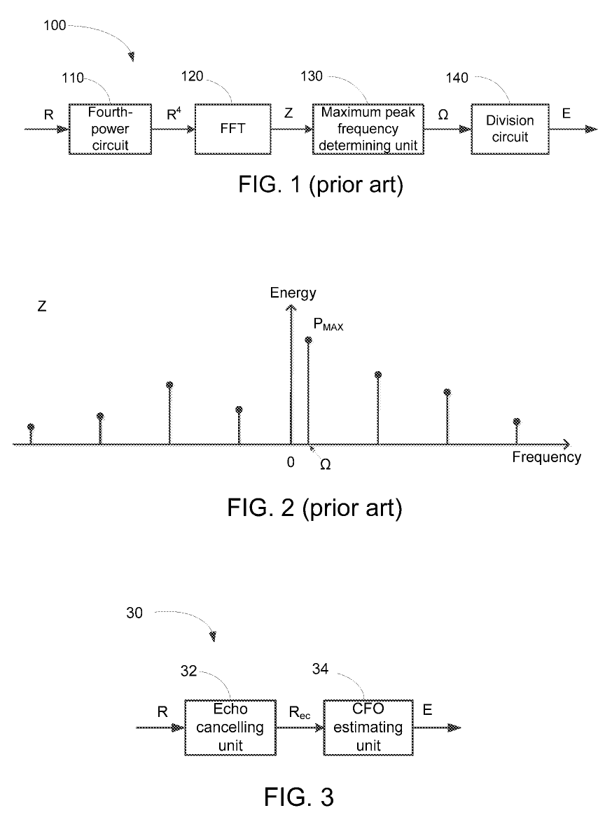

### DETAILED DESCRIPTION OF THE INVENTION

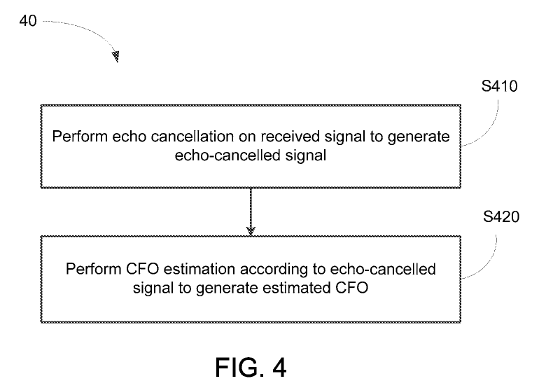

FIG. 3 shows a block diagram of a carrier frequency offset (CFO) estimation device 30 according to an embodiment of the present invention. The CFO estimation device 30 includes an echo cancelling unit 32 and a CFO estimating unit 34. FIG. 4 shows a flowchart of a CFO estimation method 40 according to an embodiment of the present invention. The echo cancelling unit 32 first performs echo cancelling on a received signal R to generate an echo-cancelled signal R_{ec} (step S410). The CFO estimating unit 34 performs CFO estimation according to the echo-cancelled signal R_{ec} to generate an estimated CFO E (step S420).

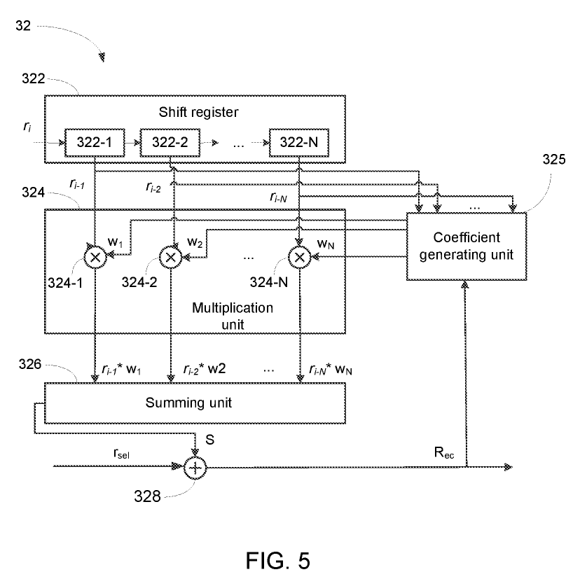

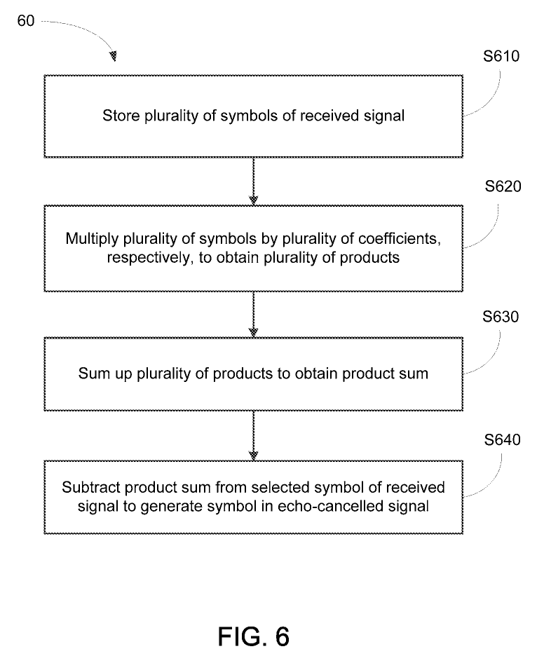

FIG. 5 shows a block diagram of an echo cancelling unit 32 according to an embodiment of the present invention. In this embodiment, the echo cancelling unit 32 is a whitening filter; however, the present invention is not limited thereto. The echo cancelling unit 32 includes a shift register 322, a multiplication unit 324, a coefficient generating unit 325, a summing unit 326 and a subtraction unit 328. FIG. 6 shows a flowchart of an echo cancelling method 60 according an embodiment of the present invention. The shift register 322 stores a plurality of symbols of the received signal R (step S610). For example, the shift register 322 includes registers 322-1 to 322-N, which receive symbols rᵢ₋₁, rᵢ₋₂, . . . and r_{i-N} of the received signal R, respectively. The multiplication unit 324 includes multipliers 324-1 to 324-N, which multiply the symbols rᵢ₋₁, rᵢ₋₂, . . . and r_{i-N} stored in the registers 322-1 to 322-N by coefficients w₁ to w_{N}, respectively, to obtain products (rᵢ₋₁*w₁), (rᵢ₋₂*w₂), . . . and (r_{i-N}*w_{N}) (step S620), wherein the coefficients w₁ to w_{N} are provided by the coefficient generating unit 325. In one embodiment, the coefficients w₁ to w_{N} may be a default value, e.g., 0, or be generated by the coefficient generating unit 325 according to the echo-cancelled signal R_{ec} and the symbols rᵢ₋₁, rᵢ₋₂, . . . and r_{i-N} stored in the shift register 322. The summing unit 326 then sums up the plurality of products above to obtain a product sum S (step S630). The subtractor 328 subtracts the product sum S from a selected symbol rₛₑₗ of the received signal R to generate a symbol in the echo-cancelled signal R_{ec} (step S640). The subtractor 328 may be implemented by an adder.

In one embodiment, the subtractor 328 is coupled to the register 322-N, and the selected symbol rₛₑₗ is the symbol r_{i-N} stored in the register 322-N, wherein the symbol r_{i-N} is the symbol received earliest among the symbols rᵢ₋₁ to r_{i-N}, so as to cancel post-echo in the received signal. In another embodiment, the subtractor 328 is coupled to an input end of the shifter register 322 and the selected symbol is the next symbol r_{N}, so as to cancel pre-echo in the received signal.

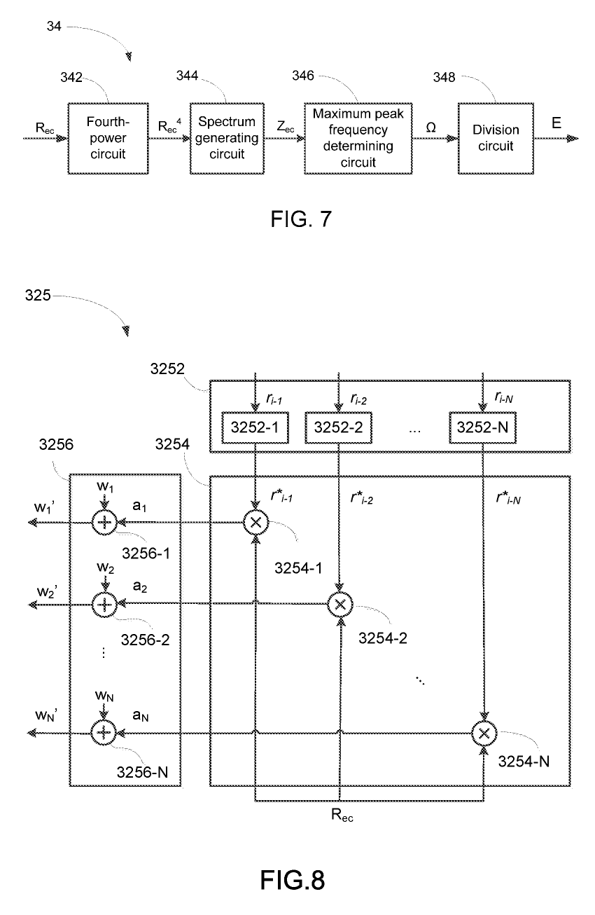

FIG. 7 shows a block diagram of a CFO estimating unit 34 according to an embodiment of the present invention. In this embodiment, the CFO estimating unit 34 is a fourth-power CFO estimator; however, the present invention is not limited thereto. The CFO estimating unit 34 includes a fourth-power circuit 342, a spectrum generating circuit 344, a maximum peak frequency determining circuit 346, and a division circuit 348. The fourth-power circuit 342 receives the echo-cancelled signal R_{ec} from the echo cancelling unit 32, and performs a fourth-power calculation on the echo-cancelled signal R_{ec} to generate a fourth-power calculation result R_{ec}⁴. The spectrum generating circuit 344 performs FFT on the fourth-power calculation result R_{ec}⁴ to generate a spectrum Z_{ec} of the fourth-power calculation result R_{ec}⁴. The maximum peak frequency determining circuit 346 identifies a maximum peak P_{MAX} from the spectrum Z_{ec}, and outputs a peak frequency Ω corresponding to the maximum peak P_{MAX}. The division circuit 348 eventually divides the peak frequency Ω by four to obtain a calculation result, and uses the calculation result as an estimated CFO E.

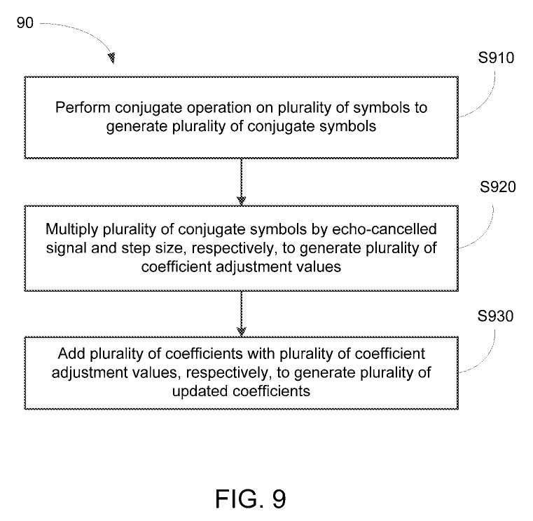

The coefficient generating unit 325 updates the coefficients w₁ to w_{N} according to the echo-cancelled signal R_{ec} and the symbols rᵢ₋₁, rᵢ₋₂, . . . and r_{i-N} stored in the shift register 322. FIG. 8 shows a block diagram of a coefficient generating unit 325 according to an embodiment of the present invention. The coefficient generating unit 325 includes a conjugate unit 3252, a multiplication unit 3254 and an adding unit 3256. FIG. 9 shows a flowchart of a coefficient generating method according to an embodiment of the present invention. The conjugate unit 3252 includes conjugators 3252-1 to 3252-N, which respectively perform a conjugate operation on the symbols rᵢ₋₁, rᵢ₋₂, . . . and r_{i-N} to generate conjugate symbols r*ᵢ₋₁, r*ᵢ₋₂, . . . and r*_{i-N} (step S910). The multiplication unit 3254 includes multipliers 3254-1 to 3254-N, which respectively multiply the conjugate symbols r*ᵢ₋₁, r*ᵢ₋₂, . . . and r*_{i-N} by the echo-cancelled signal R_{ec} and a step size (not shown) to generate coefficient adjustment values a₁ to a_{N} (step S920). The step size is used for adjusting magnitudes of the adjustment values a₁ to a_{N}, e.g., 0.1, and may be designed according to actual requirements in practice. More specifically, the adjustment values a₁ to a_{N} get larger as the step size increases, and the adjustment amount of the coefficients w₁ to w_{N} also increases. The adding unit 3256 includes adders 3256-1 to 3256-N, which respectively add the adjustment values a₁ to a_{N} to the coefficients w₁ to w_{N} to generate updated coefficients w₁′ to w_{N}′ (step S930). The updated coefficients w₁′ to w_{N}′ are respectively multiplied with updated r*ᵢ, r*ᵢ₋₁, . . . and r*_{i-(N-1)} in the shift register 322 to generate a next symbol in the echo-cancelled signal R_{ec}.

In conclusion, the received signal R first passes through the echo cancelling unit 32 to undergo echo cancellation and becomes the echo-cancelled signal R_{ec}, and then enters the CFO estimating unit 32 to undergo CFO estimation, that is, the input signal of the CFO estimating unit is the echo-cancelled signal R_{ec}. Thus, the peak frequency Ω corresponding to the maximum peak P_{MAX} of the spectrum Z_{ec} can be prevented from significantly deviating from four times the echo and thus from causing inaccurate CFO estimation of the CFO estimating unit 34. In other words, first performing echo cancellation on the received signal R by the echo cancelling unit 32 effectively enhances the accuracy of the CFO estimation device 30.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A carrier frequency offset (CFO) device, comprising:
an echo cancelling unit, performing echo cancellation on a received signal to generate an echo-cancelled signal; and
a CFO estimating unit, performing CFO estimation on the echo-cancelled signal to generate an estimated CFO.

2. The CFO estimation device according to claim 1, wherein the echo cancelling unit is a whitening filter.

3. The CFO estimation device according to claim 2, wherein the whitening filter comprises:
a shift register, storing a plurality of symbols of the received signal;
a first multiplication unit, respectively multiplying the plurality of symbols by a plurality of coefficients to generate a plurality of first products;
a summing unit, summing up the plurality of first products to generate a product sum; and
a subtraction unit, performing a subtraction calculation according to the product sum and a selected symbol of the received signal to generate the echo-cancelled signal.

4. The CFO estimation device according to claim 3, further comprising:
a coefficient providing unit, updating the plurality of coefficients according to the echo-cancelled signal and the plurality of symbols to generate a plurality of updated coefficients.

5. The CFO estimation device according to claim 3, wherein the coefficient providing unit comprises:
a conjugate unit, performing a conjugate operation on the plurality of symbols to generate a plurality of conjugate symbols;
a second multiplication unit, respectively multiplying the plurality of conjugate symbols by the echo-cancelled signal and a step size to generate a plurality of coefficient adjustment values; and
an adding unit, adding the plurality of coefficient adjustment values to the plurality coefficients to generate the plurality of updated coefficients.

6. The CFO estimation device according to claim 3, wherein the selected symbol is a symbol received earliest among the plurality of symbols so as to cancel post-echo in the received signal.

7. The CFO estimation device according to claim 3, wherein the selected symbol is a next symbol of the received signal so as to cancel pre-echo in the received signal.

8. A carrier frequency offset (CFO) estimation method, comprising:
performing echo cancellation on a received signal to generate an echo-cancelled signal; and
performing CFO estimation according to the echo-cancelled signal to generate an estimated CFO.

9. The CFO estimation method according to claim 8, wherein the step of performing the echo cancellation on the received signal to generate the echo-cancelled signal comprises:
storing a plurality of symbols of the received signal;
multiplying the plurality of symbols by a plurality of coefficients, respectively, to generate a plurality of first products;
summing up the plurality of first products to generate a product sum; and
performing a subtraction calculation according to the product sum and a selected symbol of the received signal to generate the echo-cancelled signal.

10. The CFO estimation method according to claim 9, further comprising:
updating the plurality of coefficients according to the echo-cancelled signal and the plurality of symbols to generate a plurality of updated coefficients.

11. The CFO estimation method according to claim 10, wherein the step of updating the plurality of coefficients according to the echo-cancelled signal and the plurality of symbols to generate the plurality of updated coefficients comprises:
performing a conjugate operation on the plurality of symbols to generate a plurality of conjugate symbols;
multiplying the plurality of conjugate symbols by the echo-cancelled signal and a step size, respectively, to generate a plurality of coefficient adjustment values; and
adding the plurality of coefficient adjustment values to the plurality of coefficients, respectively, to generate the plurality of updated coefficients.

12. The CFO estimation method according to claim 9, wherein the selected symbol is a symbol received earliest among the plurality of symbols so as to cancel post-echo in the received signal.

13. The CFO estimation method according to claim 9, wherein the selected symbol is a next symbol of the received signal so as to cancel pre-echo in the received signal.
